(19) United States
(12) Patent Application Publication
(10) Pub. No.: US 2025/0165410 A1
(43) Pub. Date: May 22, 2025

(54) LATENCY-DRIVEN SHARED BUFFER ALGORITHM

(71) Applicant: MELLANOX TECHNOLOGIES, LTD., Yokneam (IL)

(72) Inventors: Niv Aibester, Herzliya (IL); Liron Mula, Herzliya (IL); Eyal Srebro, Kfar Yehoshua (IL)

(21) Appl. No.: 18/516,833

(22) Filed: Nov. 21, 2023

(51) Int. Cl. G06F 13/16

(52) U.S. Cl. CPC G06F 13/1673

(57) ABSTRACT

A network device, a network interface controller, and a switch are provided. In one example, a shared buffer includes a plurality of portions, one or more ports read data from the shared buffer and write data to the shared buffer, and a controller circuit correlates egress ports with available portions among the plurality of portions as close as possible to a respective egress port.

### FIELD OF THE DISCLOSURE

The present disclosure is generally directed toward networking and, in particular, toward networking devices, switches, and methods of operating the same.

### BACKGROUND

Switches and similar network devices represent a core component of many communication, security, and computing networks. Switches are often used to connect multiple devices, device types, networks, and network types.

Devices, including but not limited to personal computers, servers, or other types of computing devices, may be interconnected using network devices such as switches. These interconnected entities form a network that enables data communication and resource sharing among the nodes.

### BRIEF SUMMARY

In accordance with one or more embodiments described herein, a computing system, such as a switch, may enable a diverse range of systems, such as switches, servers, personal computers, and other computing devices, to communicate across a network. A plurality of blocks or memory of the computing system may function as a shared buffer, allowing multiple ports of the computing system to share buffer space.

Each port of the computing system may be associated with an ingress queue of packets and/or data in other formats received via the port. Each port may store the data in one or more blocks of memory of a shared buffer, which is selected based on a general algorithm, local-RAM-occupancy, physical-location (e.g., location relative to an associated egress port for the data), shared buffer configuration/schemas, etc. A shared buffer control and rebalancing system may be used to control which port writes to and/or reads from which particular block of the shared buffer.

Shared buffer rebalancing capabilities as described herein allows the dynamic binding of ingress ports to portions of a shared buffer in order to implement an abstraction of the shared buffer. In embodiments, an ingress port is dynamically bound to available portion(s) of the shared buffer that is closest to the egress port associated with the data to be transferred. The latency-driven shared buffer algorithm of the present disclosure enhances the rebalancing algorithm, by considering forwarding “locality” or distance (e.g., physical location of an egress port or set of egress ports Tq/set-of-Tqs relative to a respective ingress port) and performs rebalancing to the “closest available” portion(s) of a shared buffer between the ingress port and a target egress port Tq/Set-Of-Tq.

As described herein, traffic may be selectively sent via one or more particular ports of a computing system based on a number of factors (e.g., fairness, minimum requirements of the buffer, quality of service (QOS) requirements, prioritize important flows, congestion control, etc.). By assessing factors and altering weights of ports or queues, switching hardware of a computing system may be enabled to route traffic through the computing system in an effective manner.

The present disclosure describes a system and method for enabling a switch or other computing system to correlate egress ports to closest available portions of a shared buffer. Embodiments of the present disclosure aim to improve forwarding latency and other issues by implementing an improved buffering allocation approach. The buffering approach depicted and described herein may be applied to a switch, a router, or any other suitable type of networking device known or yet to be developed.

In an illustrative example, a system is disclosed that includes a shared buffer, wherein the shared buffer includes a plurality of portions; and a plurality of ports, wherein each port of the plurality of ports comprise a forwarding database to correlate an egress port with at least one of the plurality of portions of the shared buffer.

In another example, a network device is disclosed that includes a shared buffer, wherein the shared buffer includes a plurality of portions; and a plurality of ports, wherein each port of the plurality of ports comprise a forwarding database to correlate an egress port with at least one of the plurality of portions of the shared buffer.

In yet another example, a method is disclose that includes writing packets to a shared buffer, wherein the shared buffer includes a plurality of portions; and forwarding the packets using a plurality of ports, wherein each port of the plurality of ports has a forwarding database that correlates an egress port with at least one of the plurality of portions of the shared buffer.

Any of the above example aspects include wherein a packet is routed to a portion of the shared buffer based on a shared buffer algorithm and a forwarding database to an available buffer portion among the plurality of portions as close as possible to an egress port associated with the packet, and wherein a closest available portion of the shared buffer is different from a portion of the shared buffer that is closest to the egress port associated with the packet. In other words, buffer allocation fairness is maintained among the ports, and packets are routed to an available buffer portion that is closest to associated egress port.

Any of the above example aspects include wherein the plurality of portions of the shared buffer are distributed among different physical locations within a device, and wherein a packet is routed to a portion among the plurality of portions that is available and as close as possible to an egress port associated with the packet.

Any of the above example aspects include wherein each forwarding database is determined, at least in part, based on reducing latency and maintaining minimum requirements of the shared buffer.

Any of the above example aspects include wherein each ingress port or group of ingress ports include a forwarding database and each forwarding database maps each ingress port with an available portion of the shared buffer as close as possible to a respective egress port.

Any of the above example aspects include wherein each port of the plurality of ports is a target egress (Tq) and an ingress target (Rq).

Any of the above example aspects include wherein the controller circuit selectively correlates an egress port with at least one of the plurality of portions of the shared buffer.

Any of the above

Any of the above example aspects include wherein the shared buffer is one of a plurality of shared buffers. example aspects include wherein data received from a first port of the one or more ports is stored in the shared buffer prior to being transmitted by a second port of the one or more ports.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a switch in accordance with at least some embodiments of the present disclosure;

FIG. 2 is a block diagram depicting an illustrative configuration of a shared buffer in accordance with at least some embodiments of the present disclosure;

FIG. 3 is a block diagram depicting an illustrative configuration of a shared buffer in accordance with at least some embodiments of the present disclosure;

FIG. 4 is a block diagram depicting an illustrative configuration of a network of switches in accordance with at least some embodiments of the present disclosure; and

FIG. 5 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

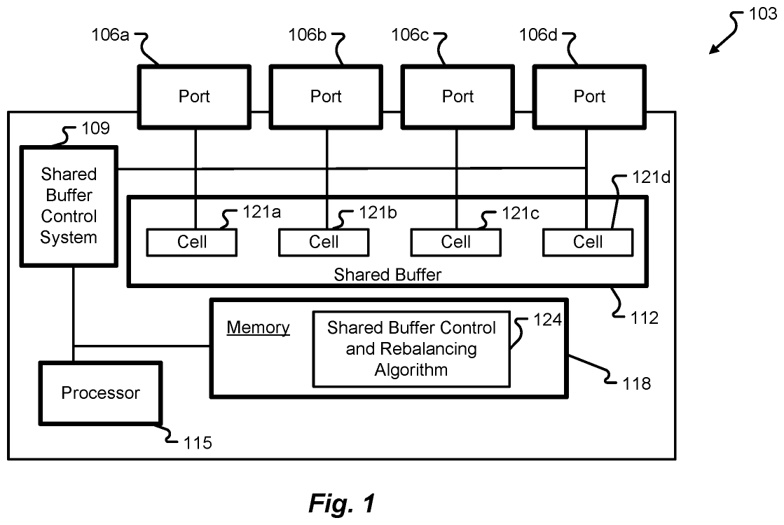

Referring now to FIGS. 1-5, various systems, and methods for managing a shared buffer in a computing system will be described. The concepts of shared buffer management depicted and described herein can be applied to any type of computing system capable of receiving and/or transmitting data, whether the computing system includes one port or a plurality of ports. Such a computing system may be a switch, but it should be appreciated any type of computing system may be used. The term packet as used herein should be construed to mean any suitable discrete amount of digitized information. The data stored in a shared buffer may be in the form of a single packet, multiple packets, or non-packetized data without departing from the scope of the present disclosure. Furthermore, it should be appreciated that described features and functions of a centralized architecture may be applied or used in a distributed architecture or vice versa.

In accordance with one or more embodiments described herein, a switch 103 as illustrated in FIG. 1 enables a diverse range of systems, such as switches, servers, personal computers, and other computing devices, to communicate across a network. While the computing device of FIG. 1 is described herein as a switch 103, it should be appreciated the computing device of FIG. 1 may be any computing device capable of receiving data via ports 106a-d. Such a switch 103 as described herein may for example be a switch or any computing device comprising a plurality of ports 106a-d for connecting nodes on a network.

The ports 106a-d of the switch 103 may function as communication endpoints, allowing the switch 103 to manage multiple simultaneous network connections with one or more nodes. Each port 106a-d may be used to receive data associated with one or more flows or communication sessions. Each port 106a-d, upon receiving data, may be capable of writing the data to a cell 121a-d within a shared buffer 112. The ports 106a-d of the switch 103 may be physical connection points which allow network cables to connect the switch 103 to one or more network nodes. The connection may be provided using any known or yet unknown communication protocols (e.g., Ethernet, InfiniBand (IB), NVLink, etc.).

Once the packets (or data in other formats) are received by ports 106a-d of the switch 103, the packets may be temporarily stored in the shared buffer 112. The shared buffer 112 may comprise a temporary storage space within the switch 103. Physically, the storage space of the shared buffer 112 may comprise a plurality of cells 121a-d, or blocks, each of which may be, for example, a Random Access Memory (RAM) device. The shared buffer 112 may operate as an intermediary holding area, allowing for the switch 103 to manage and control the onward transmission of packets from the buffer 112. Packet buffering allows a switch to address forwarding-decision latency, egress-congestion, scheduling considerations (e.g., QoS), etc.

The shared buffer may be of a particular amount of storage space, such as 156 MB, 256 MB, etc., and may comprise a plurality of RAM devices. Each RAM device may be a type of computer memory capable of being used to store data such as packets received via ports 106a-d. The smallest unit of RAM may be a cell 121a-d, and each cell stores a bit or byte of data. Each cell 121a-d in the shared buffer 112 may comprise a transistor and a capacitor. The transistor may operate as a switch that lets control circuitry of the switch read the capacitor or change its state. The capacitor may operate to hold a bit of information, either a 0 or a 1.

The shared buffer 112 may comprise cells anywhere within the switch 103. For example, the cells 121a-d may be parts of arrays or blocks of memory, such as 1 MB per block. Blocks of memory may contain cells 121a-d arranged in rows and columns.

The shared buffer 112 may comprise a RAM device organized into one or more arrays of cells.

Each cell 121a-d may be assigned a particular address which may be used by components of the switch 103 to access or instruct other components to access each particular cell 121a-d. When the processor needs to read or write a specific bit of data, it sends the corresponding memory address to the RAM. In some implementations, each block of the shared buffer 112 may be assigned an address and components may refer generally to a particular block as opposed to the more particular cell reference. In some implementations, the address of a cell (e.g., RAM location) 121a-d may indicate which block the cell 121a-d is in and a row and column for the cell 121a-d within the block. In this way, a processor 115, a shared buffer control system 109, and/or another component of the switch 103 may be enabled to refer to any particular cell 121a-d and/or all cells of a particular block of the shared buffer 112.

In some implementations, the cells 121a-d of the shared buffer 112 may form a single, fragmented logical unit. To a port 106a-d, the shared buffer 112 may appear to be a single unit of memory. Each port 106a-d may write data to any one of the cells 121a-d in the shared buffer memory 118. Which cell 121a-d to which a particular port 106a-d writes a received packet may be controlled by a shared buffer control system 109. For example, the shared buffer control system 109 may instruct each port 106a-d to write to a particular cell 121a-d. In some implementations, the shared buffer control system 109 may be enabled to correlate particular cells 121a-d and/or particular blocks of the shared buffer 112 to egress ports. In embodiments, the cells 121ad-d and egress ports are correlated based on “locality,” or relative location to each other.

To read data from a cell 121a-d, control circuitry of the switch 103 may cause the transistor to allow the charge on the capacitor to flow out onto a bit line. Buffered packets may in some implementations be organized in queues, such as associated with a dedicated queue per egress port, as the packets await transmission.

The shared buffer control system 109 may be in communication with or controlled by a processor 115. For example, the switch 103 may comprise a processor 115, such as a central processing unit (CPU), a microprocessor, or any circuit or device capable of reading instructions from memory 118 and performing actions. The processor 115 may execute software instructions to control operations of the switch 103.

The processor 115 may function as the central processing unit of the switch 103 and execute operative capabilities of the switch 103. The processor 115 may communicate with other components of the switch 103, including the shared buffer control system 109, such as to manage and perform computational operations.

The processor 115 may be configured to perform a wide range of computational tasks. Capabilities of the processor 115 may encompass executing program instructions, managing data within the system, and controlling the operation of other hardware components such as shared buffer control system 109. The processor 115 may be a single-core or multi-core processor and might include one or more processing units, depending on the specific design and requirements of the switch 103. The design of the processor 115 may allow for instruction execution, data processing, and overall system management, thereby enabling the performance and utility of switch 103 in various applications. Furthermore, the processor 115 may be programmed or adapted to execute specific tasks and operations according to application requirements, thus potentially enhancing the versatility and adaptability of the switch 103.

The switch 103 may also include one or more memory 118 components which may store data such as a shared buffer control and rebalancing algorithm 124. Memory 118 may be configured to communicate with the processor 115 of the switch 103. Communication between memory 118 and the processor 115 may enable various operations, including but not limited to, data exchange, command execution, and memory management. In accordance with implementations described herein, memory 118 may be used to store data, such as shared buffer control and rebalancing algorithm 124, relating to the usage of the cells 121a-d of the shared buffer 112 of the switch 103.

The memory 118 may be constituted by a variety of physical components, depending on specific type and design. Memory 118 may include one or more memory cells capable of storing data in the form of binary information. Such memory cells may be made up of transistors, capacitors, or other suitable electronic components depending on the memory type, such as dynamic random-access memory (DRAM), static random-access memory (SRAM), or flash memory. To enable data transfer and communication with other parts of the switch 103, memory 118 may also include data lines or buses, address lines, and control lines not illustrated in FIG. 1. Such physical components may collectively constitute the memory 118 and/or the shared buffer 112, contributing to their capacity to store and manage data, such as shared buffer control and rebalancing algorithm 124.

Shared buffer control and rebalancing algorithm 124, as which may be stored in memory 118, could encompass information about various aspects of shared buffer 112 usage. Such information might include data about current buffer usage and location of available portions, among other things. Shared buffer control and rebalancing algorithm 124 may include, for example, a current number of active cells 121a-d, a total number of cells 121a-d, a current number of inactive cells 121a-d, and/or other data, as described in greater detail below.

The shared buffer control and rebalancing algorithm 124 may be accessed and utilized by the processor 115 and/or the shared buffer control system 109 in managing operations of the shared buffer and ports 106a-d. For example, the processor 115 might utilize the shared buffer control and rebalancing algorithm 124 to manage network traffic received by ports 106a-d by determining which cells are closest to egress ports for particular portions of the traffic as described in greater detail below. Therefore, the memory 118, in potential conjunction with the processor 115, may play a crucial role in optimizing the usage and performance of the ports 106a-d of the switch 103.

In one or more embodiments of the present disclosure, a processor 115 or shared buffer control system 109 of a switch 103 may execute polling operations to retrieve data relating to activity of the cells 121a-d, such as by polling the cells 121a-d, the shared buffer 112, the shared buffer control and rebalancing algorithm 124, the shared buffer control system 109, and/or other components of the switch 103 as described herein. As used herein, polling may involve the processor 115 periodically or continuously querying or requesting data from the shared buffer control system 109 or may involve the processor 115 or the shared buffer control system 109 periodically or continuously querying or requesting data from the cells 121a-d or from memory 118. The polling process may in some implementations encompass the processor 115 sending a request to the shared buffer control system 109 to retrieve desired data. Upon receiving the request, the shared buffer control system 109 may compile the requested data and send it back to the processor 115.

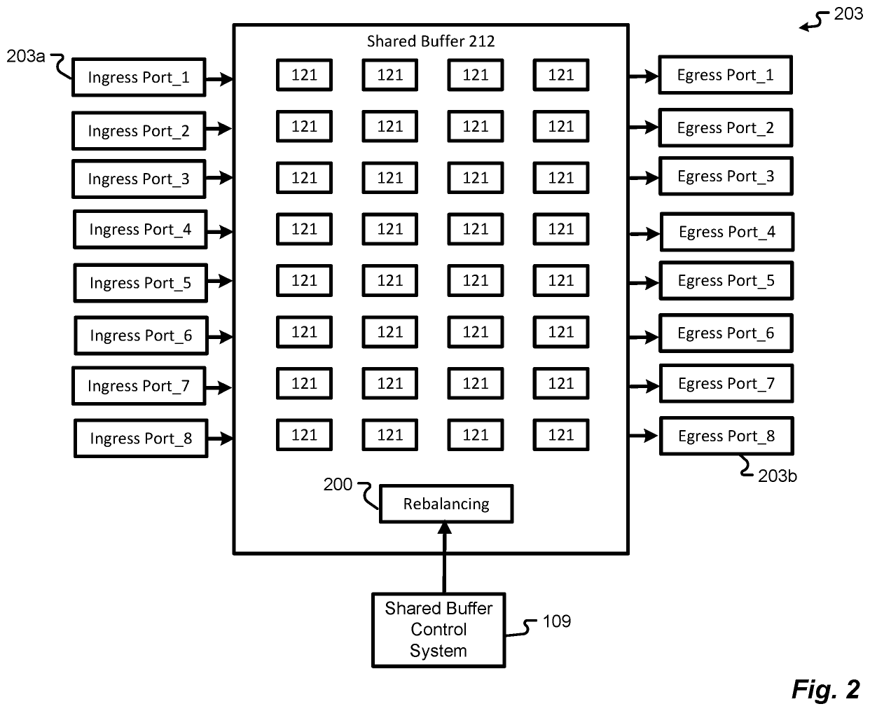

As illustrated in FIG. 2, similar to ports 106a-d, ingress ports 203a and egress ports 203b of a switch 203 may write/read data to a shared buffer 212. Each port 203a or 203b may write/read to a particular cell 121 of the shared buffer 212 based on instructions received by a shared buffer control system 109. In other words, each ingress port 203a may be dynamically bound to available portion(s) 121 of the shared buffer 112 that is closest to the egress port 203b associated with the data to be transferred. Rather than each ingress port 203a always writing data to specific portion(s) of the shared buffer 121, correlations between ingress ports 203a and portions 121 are dynamic and may be adjusted based on availability (occupancy of each portion 121), destination for the data, etc. For example, the ingress port_1 may have data for egress port_1 and egress port_8, so the ingress port_1 may be dynamically bound to closest available portions 121 to the egress port_1 and the egress port_8. At another point in time, the ingress port_1 may have data for egress port_3 and egress port_6, so the ingress port_1 may be dynamically bound to closest available portions 121 to the egress port_3 and the egress port_6. The ports 203a-b may also report buffer usage to the shared buffer control system 109. The buffer usage information may be used to rebalance the shared buffer 212 via rebalancing 200.

As described herein, data, such as packets, may be sent via a particular one or more of the ports 203a to cells 121 of the shared buffer 212 selectively based on a number of factors. A shared buffer control system 109 of the switch 203 may comprise one or more application-specific integrated circuits (ASICs) or microprocessors to perform tasks such as determining to which cell 121a received packet should be sent. The shared buffer control system 109 may comprise various components including, for example, port controllers that manage the operation of individual ports, network interface cards that facilitate data transmission, and internal data paths that direct the flow of data within the switch 203. The shared buffer control system 109 may also include memory elements to temporarily store data and management software to control the operation of the switch 203. Such a configuration may enable the shared buffer control system 109 to accurately track shared buffer usage and provide data to the processor 115 of the switch 103 upon request.

The shared buffer control system 109 may control the management and rebalancing of the shared buffer 212 by governing which port writes to each block of the shared buffer. The decision as to which port 203 writes to which cell 121 of the shared buffer 112 may be based on factors such as occupancy of the shared buffer 112, location, quotas, required pool-size, μBurst conditions, etc.

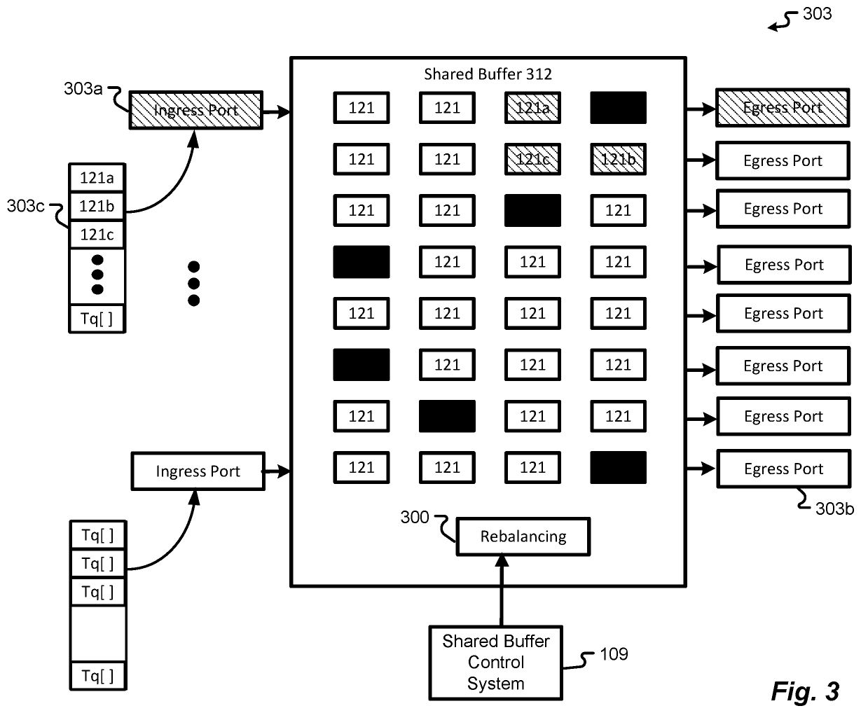

As illustrated in FIG. 3, data coming into ingress port 303a (diagonal lines) may be destined for egress port 303b (with matching diagonal lines). The ingress port 303a includes a forwarding database 303c (e.g., a forwarding table) that indicates the closest available portions 121a-c of the shared buffer 312 to the egress port 303b. As illustrated, portion 121d is closest to the egress port 303b, however, the grey shaded portions 121 are occupied/unavailable portions of the shared buffer 312. In addition to the forwarding databases 303c, flows are generally routed based on control-plan, which includes shared buffer algorithms, forwarding tables, and dynamic/static or complex stateful rules. Each forwarding database 303c is implemented to map the corresponding best-match portion (e.g., closest available) of shared buffer 312 for each egress port 303b.

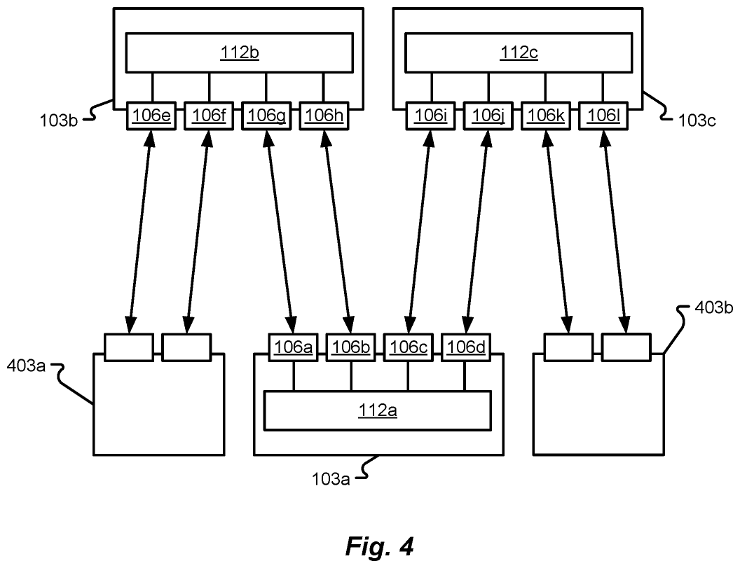

As illustrated in FIG. 4, a switch 103a may be connected to a number of nodes such as other switches 103b, 103c, and/or other computing devices 403a, 403b, forming a network. The systems and methods described herein may be performed by a switch 103a-c in a network of interconnected nodes. Multiple switches 103a-c, and/or other computing devices 403a, 403b, can be interconnected in a variety of topologies, such as star, ring, or mesh, depending upon the specific requirements and resilience needed for the network. For instance, in a star topology, a plurality of switches may be connected to a central switch, whereas in a ring topology, each switch may be connected to two other switches in a closed loop. In a mesh topology, each switch may be interconnected with every other switch in the network. These robust structures afford a level of redundancy, as there are multiple paths for data to travel, ensuring that network functionality can be maintained even in the event of a switch failure.

Each switch 103a-c may be a switch 103 such as illustrated in FIG. 1 or may be any type of computing device. Each port 106a-l of each switch 103a-c may be connected to the same or a different node. In the example illustrated in FIG. 4, a first switch 103a is connected via two ports 106a-b to two ports 106g-h of a second switch 103b and via two ports 106c-d to two ports 106i-j of a third switch 103c. Each of the second and third switches 103b-c are connected to other computing devices 403a-b via two ports 106e, 106f, 106k, 106l. Each of the switches 103a-c may comprise a respective shared buffer 112a-c. When a packet is received via a port 106a-1 of a switch 103a-c, the packet may be stored in a shared buffer 112a-c of the respective switch 103a-c.

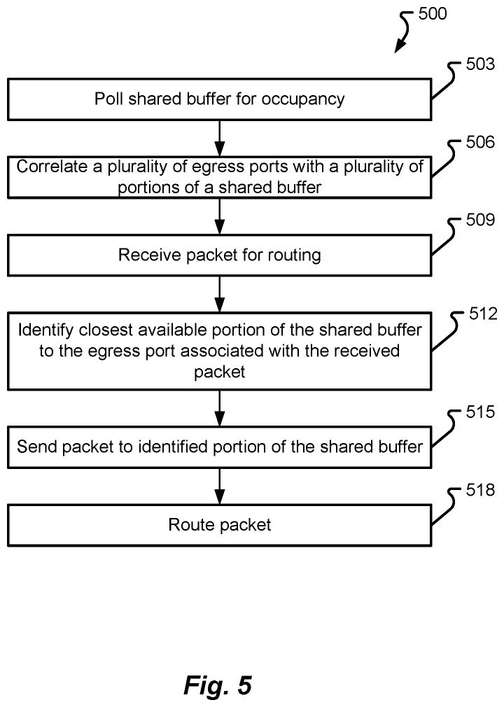

As illustrated in FIG. 5, a method 500 as described herein may be performed by a switch 103, or other computing device, in accordance with one or more of the embodiments described herein. The method 500 involves identifying information relating to usage of a shared buffer, determining available portions of the shared buffer to correlate available portions of the shared buffer to egress ports by location (e.g., correlate available portions closest to a particular egress port). While the features of the method 500 are described as being performed by a shared buffer control system 109 of a switch 103, 203, and 303, it should be appreciated that one or more of the functions may be performed by a processor 115, a rebalancing system 300, or any other computing device comprised by or in communication with a switch 103, 203, and 303.

In some implementations, the method may be performed by a network device such as a NIC, a switch, a controller circuit of a switch, or any computing device including a shared buffer. Data received from a first port of a plurality of ports may in some implementations be stored in a shared buffer prior to being transmitted by a second port of the one or more ports. Furthermore, while the description provided herein relates to the use of a shared buffer used by ports, it should be appreciated any computing system element capable of writing data in memory may use a shared buffer in the same or similar ways as described herein. As such the systems and methods described herein may be used by any entity which uses a shared buffer. Also, the shared buffer may be one of a plurality of shared buffers. A controller, such as a microprocessor, an ASIC, or any other type of computing element may selectively enable and disable cells of memory of each of the shared buffers in accordance with the method 500 described herein.

At step 503, occupancy of a shared buffer 112 of the switch 103 may be determined by the shared buffer control system 109. For example, the shared buffer control system 109 may poll the switch 103 for the occupancy of the shared buffer 112. This may include occupancy/availability of each cell/portion 121.

Determining the occupancy of the shared buffer 112 of the switch 103 may comprise polling the occupancy of the shared buffer 112. Polling the occupancy may involve a processor 115 or a shared buffer control system 109 within the switch 103 repeatedly querying or examining the current state of the shared buffer 112, to measure how much of the capacity is being utilized at a specific moment. The polling process could occur at regular intervals, or may be event-driven, triggered by certain conditions or changes in the switch's state. The polling operation may result in a quantitative measure of buffer occupancy, such as an occupancy of each portion 121 of the shared buffer 112.

At step 506, a plurality of egress ports is correlated with a plurality of portions of a shared buffer. For example, the shared buffer control system 109 correlates the egress ports 303b with available portions 121 of the shared buffer 112 that are closest to each respective egress port 303b.

At step 509, a packet(s) is received at an ingress port 303a for routing.

At step 512, the shared buffer control system 109 or the processor 115 identifies a closest available portion 121 of the shared buffer 112 to the egress port 303b associated with the received packet(s). In embodiments, a forwarding database 303c associated with the ingress port 303a is used to determine which portion 121 of the shared buffer 112 the packet(s) should be written to.

At step 515, the shared buffer control system 109 or the processor 115 sends the received packet(s) to the identified portion(s) 121 of the shared buffer 112. For example, the packet(s) is written to one of portions 121a-c.

At step 518, the shared buffer control system 109 or the processor 115 routes the received packet(s) via the associated egress port.

In one or more embodiments of the present disclosure, the method 500, after executing, may return to 503 and recommence the process. In some implementations, the repetition of method 500 may occur without delay. In such cases, as soon as the method 500 concludes, the method 500 may immediately begin the next iteration. This arrangement could allow for a continuous execution of method 500. In some implementations, a pause for a predetermined amount of time may occur between successive iterations of method 500. The duration of the pause may be specified as per the operational needs of the method such as by a user.

The present disclosure encompasses methods with fewer than all of the steps identified in FIG. 5 (and the corresponding description of the method), as well as methods that include additional steps beyond those identified in FIG. 5 (and the corresponding description of the method). The present disclosure also encompasses methods that comprise one or more steps from the methods described herein, and one or more steps from any other method described herein.

Embodiments of the present disclosure include a system, comprising: a shared buffer, wherein the shared buffer includes a plurality of portions; and a plurality of ports, wherein each port of the plurality of ports comprise a forwarding database to correlate an egress port with at least one of the plurality of portions of the shared buffer.

Embodiments of the present disclosure also include a network device with shared buffer capabilities, comprising: a shared buffer, wherein the shared buffer includes a plurality of portions; and a plurality of ports, wherein each port of the plurality of ports comprise a forwarding database to correlate an egress port with at least one of the plurality of portions of the shared buffer.

Embodiments of the present disclosure also include a method for shared buffer rebalancing, comprising: writing packets to a shared buffer, wherein the shared buffer includes a plurality of portions; and forwarding the packets using a plurality of ports, wherein each port of the plurality of ports has a forwarding database that correlates an egress port with at least one of the plurality of portions of the shared buffer.

Aspects of the above system, device, switch, and/or method include wherein a packet is routed to a portion of the shared buffer based at least partly on the forwarding database to an available portion among the plurality of portions as close as possible to an egress port associated with the packet, and wherein a closest available portion of the shared buffer is different from a portion of the shared buffer that is closest to the egress port associated with the packet.

Aspects of the above system, device, switch, and/or method include wherein the plurality of portions of the shared buffer are distributed among different physical locations within a device, and wherein a packet is routed to a portion among the plurality of portions that is available and as close as possible to an egress port associated with the packet.

Aspects of the above system, device, switch, and/or method include wherein each forwarding database is determined, at least in part, based on reducing latency and maintaining minimum requirements of the shared buffer.

Aspects of the above system, device, switch, and/or method include wherein each forwarding database maps each egress port with an available portion of the shared buffer as close as possible to a respective egress port.

Aspects of the above system, device, switch, and/or method include wherein each port of the plurality of ports is a target egress (Tq) and an ingress target (Rq).

Aspects of the above system, device, switch, and/or method include wherein the controller circuit selectively correlates an egress port with at least one of the plurality of portions of the shared buffer.

Aspects of the above system, device, switch, and/or method include wherein data received from a first port of the one or more ports is stored in the shared buffer prior to being transmitted by a second port of the one or more ports.

Aspects of the above system, device, switch, and/or method include wherein the shared buffer is one of a plurality of shared buffers.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a shared buffer, wherein the shared buffer includes a plurality of portions; and
a plurality of ports, wherein each port of the plurality of ports comprises a forwarding database to correlate an egress port with at least one of the plurality of portions of the shared buffer.

2. The system of claim 1, wherein a packet is routed to a portion of the shared buffer based at least partly on the forwarding database to an available portion among the plurality of portions as close as possible to an egress port associated with the packet, and wherein a closest available portion of the shared buffer is different from a portion of the shared buffer that is closest to the egress port associated with the packet.

3. The system of claim 1, wherein the plurality of portions of the shared buffer are distributed among different physical locations within a device, and wherein a packet is routed to a portion among the plurality of portions that is available and as close as possible to an egress port associated with the packet.

4. The system of claim 3, wherein the device comprises a network switch.

5. The system of claim 1, wherein each forwarding database is determined, at least in part, based on reducing latency and maintaining minimum requirements of the shared buffer.

6. The system of claim 1, wherein each forwarding database maps each egress port with an available portion of the shared buffer as close as possible to a respective egress port.

7. The system of claim 1, wherein each port of the plurality of ports is a target egress (Tq) and an ingress target (Rq).

8. A network device with shared buffer capabilities, the network device comprising:
a shared buffer, wherein the shared buffer includes a plurality of portions; and
a plurality of ports, wherein each port of the plurality of ports comprises a forwarding database to correlate an egress port with at least one of the plurality of portions of the shared buffer.

9. The network device of claim 8, wherein a packet is routed to a portion of the shared buffer based at least partly on the forwarding database to an available portion of the shared buffer as close as possible to an egress port associated with the packet, and wherein a closest available portion of the shared buffer is not a portion of the shared buffer that is closest to the egress port associated with the packet.

10. The network device of claim 8, wherein the plurality of portions of the shared buffer are distributed among different physical locations within a device, and wherein a packet is routed to a portion of the shared buffer that is available and as close as possible to an egress port associated with the packet.

11. The network device of claim 8, wherein each forwarding database is determined, at least in part, based on reducing latency and maintaining minimum requirements of the shared buffer.

12. The network device of claim 8, wherein each forwarding database maps each egress port with an available portion of the shared buffer as close as possible to a respective egress port.

13. The network device of claim 8, wherein the network device comprises a network switch.

14. The network device of claim 8, wherein each port of the plurality of ports is a target egress (Tq) and an ingress target (Rq).

15. A method for shared buffer rebalancing, the method comprising:
writing packets to a shared buffer, wherein the shared buffer includes a plurality of portions; and
forwarding the packets using a plurality of ports, wherein each port of the plurality of ports has a forwarding database that correlates an egress port with at least one of the plurality of portions of the shared buffer.

16. The method of claim 15, wherein a packet is routed to a portion of the shared buffer based at least in part on the forwarding database to an available portion of the shared buffer as close as possible to an egress port associated with the packet, and wherein a closest available portion of the shared buffer is not a portion of the shared buffer that is closest to the egress port associated with the packet.

17. The method of claim 15, wherein the plurality of portions of the shared buffer are distributed among different physical locations within a device, and wherein a packet is routed to a portion of the shared buffer that is available and as close as possible to an egress port associated with the packet.

18. The method of claim 17, wherein the device comprises a network switch.

19. The method of claim 15, wherein each forwarding database is determined, at least in part, based on reducing latency and maintaining minimum requirements of the shared buffer.

20. The method of claim 15, wherein each forwarding database maps each egress port with an available portion of the shared buffer as close as possible to a respective egress port.
